(19) United States
(12) Patent Application Publication
(10) Pub. No.: US 2026/0212139 A1
(43) Pub. Date: Jul. 23, 2026

(54) METHOD FOR GENERATING SUBTITLE, ELECTRONIC DEVICE AND STORAGE MEDIUM

(71) Applicant: Beijing Baidu Netcom Science Technology Co., Ltd., Beijing (CN)

(72) Inventors: Zecheng HAN, Beijing (CN); Yu LIU, Beijing (CN); Aiwen HUANG, Beijing (CN); Jiani LIN, Beijing (CN)

(21) Appl. No.: 19/567,901

(22) Filed: Mar. 16, 2026

(30) Foreign Application Priority Data
Sep. 29, 2025 (CN) 202511415032.2

(51) Int. Cl. G06F 40/58; G10L 17/02; G10L 25/57

(52) U.S. Cl. CPC G06F 40/58; G10L 17/02; G10L 25/57

(57) ABSTRACT

Provided is a method for generating subtitle, an electronic device and a storage medium, relating to the field of computer technologies, and especially to the technical fields of artificial intelligence, natural language processing, signal processing, software engineering and interactive design. The method includes: determining a target video; segmenting audio data of the target video to obtain a plurality of target audio segments; obtaining a plurality of text segments by performing speech recognition on the plurality of target audio segments according to a concurrent processing mechanism, wherein the plurality of text segments correspond to the plurality of target audio segments in a one-to-one correspondence; obtaining a target subtitle text by performing translation processing on the plurality of text segments.

### CROSS-REFERENCE TO RELATED APPLICATIONS

The present application claims priority to Chinese Patent Application No. CN202511415032.2, filed with the China National Intellectual Property Administration on Sep. 29, 2025, the disclosure of which is hereby incorporated herein by reference in its entirety.

### TECHNICAL FIELD

The present disclosure relates to the field of computer technologies, and especially to the technical fields of artificial intelligence, natural language processing, signal processing, software engineering and interactive design, and in particular, to a method and apparatus for generating subtitle, an electronic device and a storage medium.

### BACKGROUND

In the context of globalization, the global spread of video contents is inevitable. However, language barriers pose a major challenge for a diverse, multilingual audience, hindering users'ability to fully understand the video contents and greatly reducing their spread effectiveness.

### SUMMARY

The present disclosure provides a method and apparatus for generating subtitle, an electronic device and a storage medium.

In a first aspect, the present disclosure provides a method for generating subtitle, including:
determining a target video;
segmenting audio data of the target video to obtain a plurality of target audio segments;
obtaining a plurality of text segments by performing speech recognition on the plurality of target audio segments according to a concurrent processing mechanism, wherein the plurality of text segments correspond to the plurality of target audio segments in a one-to-one correspondence;
obtaining a target subtitle text by performing translation processing on the plurality of text segments.

In a second aspect, the present disclosure provides an apparatus for generating subtitle, including:
a video determination unit configured to determine a target video;
an audio segmentation unit configured to segment audio data of the target video to obtain a plurality of target audio segments;
a speech recognition unit configured to obtain a plurality of text segments by performing speech recognition on the plurality of target audio segments according to a concurrent processing mechanism, wherein the plurality of text segments correspond to the plurality of target audio segments in a one-to-one correspondence; and
a text translation unit configured to obtain a target subtitle text by performing translation processing on the plurality of text segments.

In a third aspect, the present disclosure provides an electronic device, including:
at least one processor; and
a memory connected in communication with the at least one processor;
where the memory stores an instruction executable by the at least one processor, and the instruction, when executed by the at least one processor, enables the at least one processor to execute the method of any embodiment of the present disclosure.

In a fourth aspect, the present disclosure provides a non-transitory computer-readable storage medium storing a computer instruction thereon, and the computer instruction is used to cause a computer to execute the method of any embodiment of the present disclosure.

In a fifth aspect, the present disclosure provides a computer program product including a computer program which, when executed by a processor, implements the method according the first aspect of the present disclosure.

By implementing the present disclosure, human labor can be saved and the time required to generate target subtitles can be significantly reduced, meeting users'demand for instant subtitle availability during real-time video playback.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are included to provide a better understanding of the present solution and are not to be construed as limiting the present disclosure. In the drawings:

FIG. 1 is a schematic flowchart of a method for generating subtitle according to an embodiment of the present disclosure;

FIG. 2 is a diagram illustrating an exemplary approach to obtaining a target audio segment according to an embodiment of the present disclosure;

FIG. 3 is a schematic flowchart of a method for generating subtitle according to an embodiment of the present disclosure;

FIG. 4 is a schematic diagram of an application scenario of the method for generating subtitle according to the embodiment of the present disclosure;

FIG. 5 is a schematic block diagram of an apparatus for generating subtitle according to an embodiment of the present disclosure;

FIG. 6 is a block diagram of an electronic device according to an embodiment of the present disclosure.

### DETAILED DESCRIPTION

Exemplary embodiments of the present disclosure are described below with reference to the accompanying drawings, in which various details of embodiments of the present disclosure are included to assist understanding, and which are to be considered as merely exemplary. It should therefore be understood that those skilled in the art may make various changes and modifications to the described embodiments without departing from the scope of the present disclosure. For the sake of clarity and conciseness, well-known functions and structures are not described in detail herein.

Currently, cross-lingual dissemination of video content primarily relies on subtitle translation. However, conventional subtitle generation methods heavily depend on manual processes, and need to go through a plurality of independent links such as “manual transcription (i.e., speech recognition)→manual translation→manual collation”. This not only consumes substantial human resources, but also cannot meet the requirement of a user for acquiring subtitles in real time when the user watches a video (e.g., an online course, a live playback, a movie, or a short video) in real time due to an extremely long subtitle generating period.

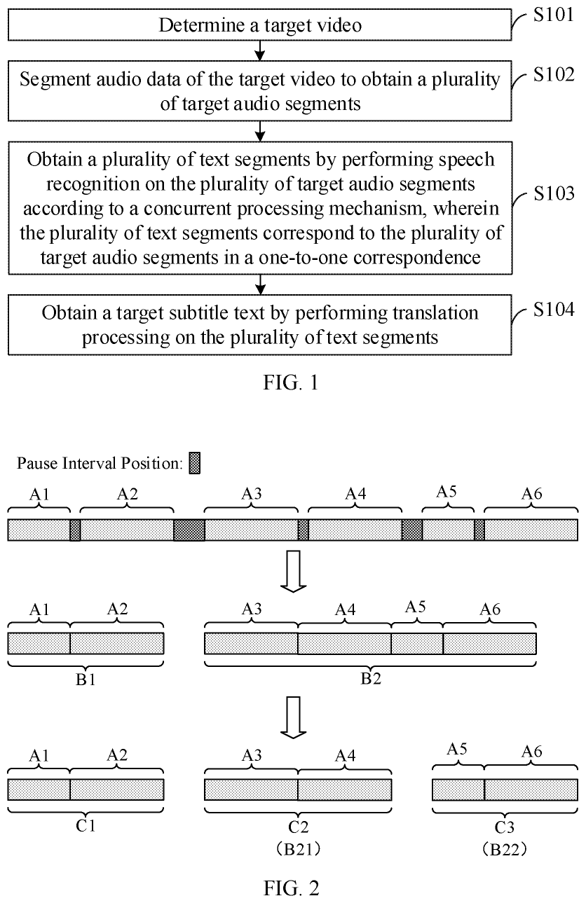

In view of the above problems, the embodiments of the present disclosure provide a method for generating subtitle, which may be applied to an electronic device. The electronic device may be a server, a workstation, a mainframe computer, or other similar computing device. Hereinafter, the method for generating subtitle according to the embodiment of the present disclosure will be described with reference to the flowchart shown in FIG. 1. It should be noted that although a logical order is shown in the flowchart shown in FIG. 1, in some cases, the steps shown or described in the flowchart may be performed in other orders.

Step S101, determining a target video.

Herein, the target video may be an online course, a live playback, a movie, or a short video, for example, which is not limited in the embodiment of the present disclosure.

Step S102, segmenting audio data of the target video to obtain a plurality of target audio segments.

Herein, the audio data may include speech data in a first language, possibly mixed with background sound. Here, the first language is an original language of the target video, which may be one of a plurality of first candidate languages, and the plurality of first candidate languages may include Chinese, English, Russian, German, French, Italian, Spanish, Japanese, Korean, and the like. The background sound may include background music, or may also include non-semantic environmental sound (e.g., environmental noise), which is not limited in the embodiment of the present disclosure.

Based on this, it should be understood that in the embodiments of the present disclosure, the target audio segment may also include speech data in the first language, and may be mixed with the background sound. In addition, in the embodiment of the disclosure, the target audio segment can have a corresponding segment identifier and timeline identifier. Here, the segment identifier can be a segment code; the timeline identifier can be represented as “Tᵢ~Tᵢ₊₁”. Here, Tᵢ represents a start time point of the target audio segment; Tᵢ₊₁ represents an end point in time of the target audio segment.

Step S103, obtaining a plurality of text segments by performing speech recognition on the plurality of target audio segments according to a concurrent processing mechanism.

In other words, in the embodiment of the present disclosure, the plurality of target audio segments undergo concurrent speech recognition to obtain the plurality of text segments, which are the plurality of text segments in the first language. The plurality of text segments correspond to the plurality of target audio segments in a one-to-one correspondence.

Step S104, obtaining a target subtitle text by performing translation processing on the plurality of text segments.

Herein, the target subtitle text may be a subtitle text in a second language different from the first language. Here, the second language may be one of a plurality of second candidate languages, and the plurality of second candidate languages may include Chinese, English, Russian, German, French, Italian, Spanish, Japanese, Korean, and the like.

By adopting the method for generating subtitle according to the embodiment of the disclosure, it is possible to obtain the target video, segment the audio data of the target video to obtain the plurality of target audio segments, then perform the speech recognition on the plurality of target audio segments according to the concurrent processing mechanism to obtain the plurality of text segments, and finally perform the translation processing on the plurality of text segments to obtain the target subtitle text. In this process, since the manual process is not involved, not only can human resources be saved, but also the generation period of the target subtitle text can be shortened, so as to meet the requirement of a user for instantly acquiring subtitles when watching videos in real time; also, in the segmentation of the audio data of the target video, the concurrent processing mechanism is employed to further shorten the generation period of the target subtitle text.

In some optional implementations, Step S101 of “determining the target video” may include:
determining the target video in response to a video translation request.

Herein, the video translation request may be sent by a target user based on a terminal device, and carries a video identifier. Here, the terminal device may be a conventional computer (e.g., a desktop, a laptop or a tablet), a smart phone, a personal digital assistant, or other similar computing device; the video identifier may be a video name, or video encoding.

The electronic device, after receiving the video translation request, may extract the video identifier from the video translation request and determine the target video from a plurality of second candidate videos based on the video identifier. Herein, the second candidate video may be an existing video content in a target network disk space. Here, the target network disk space may be the network disk space of the target user.

In the above manner, according to the embodiment of the present disclosure, it is possible to determine the target video in response to the video translation request, thereby improving the autonomous determination controllability of the target video. In other words, according to the embodiment of the present disclosure, a clear video translation request may be received, and a processing object of the subtitle generation method may be directly specified based on the video translation request. That is, the target video is directly specified, so as to achieve accurate matching between the target video and a user requirement and avoid unnecessary waste of computing resources.

In some optional implementations, Step S101 of “determining the target video” may also include:
determining a first candidate video;
obtaining an original language category of the first candidate video; and
taking the first candidate video as the target video in the case that the original language category is different from a reference language category.

Herein, the first candidate video may be the latest video content in the target network disk space.

In the embodiment of the present disclosure, the original language category may be Chinese, English, Russian, German, French, Italian, Spanish, Japanese, Korean, and the like; the reference language category may be a common language category of the target user (e.g., a native language category of the target user), which may be set by the target user, or may be determined based on a historical subtitle generating event triggered by the target user, which is not limited in the embodiment of the present disclosure.

Furthermore, it should be noted that, according to the embodiment of the present disclosure, the first candidate video may be taken as the target video when the original language category is different from the reference language category and the current time period is the night time period. The night time period can be set according to application requirements. For example, the night time period can be set to be 00:00 A.M. to 8:00 A.M., which is not limited in the embodiment of the present disclosure.

In the above manner, according to the embodiment of the present disclosure, it is possible to determine the first candidate video, obtain the original language category of the first candidate video, and then take the first candidate video as the target video under the condition that the original language category is different from the reference language category. That is to say, in the embodiment of the present disclosure, the subtitle generation process may be converted from passive “synchronous processing” to active “asynchronous calculation” by predicting a user requirement, so that the user may directly obtain an instantaneous result when there is an actual subtitle acquisition request, thereby effectively solving the problems of delay and resource contention caused by synchronous processing in a high-concurrency scenario.

After the target video is determined, Step S102 of segmenting the audio data of the target video to obtain the plurality of target audio segments may be performed.

In the embodiment of the present disclosure, Step S102, as the first optional implementation, may include:
segmenting the audio data of the target video according to a preset segment length to obtain the plurality of target audio segments.

Herein, the preset segment length may be set according to an application requirement. For example, the preset segment length may be set to 30 seconds(S), which is not limited in the embodiment of the present disclosure. The target audio segment may be in a Waveform sound file (WAV) format.

In the above manner, according to the embodiment of the present disclosure, it is possible to segment the audio data of the target video according to the preset segment length to obtain the plurality of target audio segments. The process does not involve a complex calculation flow, thereby improving the acquisition efficiency of the target audio segment.

In the embodiment of the present disclosure, Step S102, as the second optional implementation, may include:
segmenting the audio data according to a pause interval position to obtain a plurality of initial audio segments;
obtaining a voiceprint feature of an initial audio segment to obtain a plurality of voiceprint features; and
merging at least a portion of the plurality of initial audio segments based on the plurality of voiceprint features to obtain the plurality of target audio segments.

Herein, the pause interval position may be a track position where the speech pause duration in the audio data exceeds a preset pause duration. Here, the preset pause duration may be set according to an application requirement. For example, the preset pause duration may be set to 2 S, which is not limited in the embodiment of the present disclosure.

In addition, in the embodiment of the present disclosure, the voiceprint feature is an acoustic fingerprint, which may be a fixed-length, low-dimensional numerical vector. In an example, a voiceprint recognition model can be utilized to obtain the voiceprint feature for the initial audio segment to obtain the plurality of voiceprint features. The voiceprint recognition model may be, but is not limited to, an Emphasized Channel Attention, Propagation And Aggregation For Time Delay Neural Network (ECAPA-TDNN), a Residual Network with Squeeze-and-Excitation Module (ResNetSE), an Enhanced Res2Net with Local and Global Feature Fusion (ERes2Net) and a Gaussian Mixture Model-Universal Background Model (GMM-UBM), which is not limited in the embodiment of the present disclosure.

After the plurality of voiceprint features are obtained, at least a portion of the plurality of initial audio segments can be merged based on the plurality of voiceprint features to obtain the plurality of target audio segments. For example, it includes:
clustering adjacent initial audio segments with similar voiceprint features in the plurality of initial audio segments into an audio segment group based on the plurality of voiceprint features to obtain a plurality of audio segment groups;
taking an audio segment group as a target segment group, and obtaining a first segment total duration of the initial audio segments included in the target segment group;
under the condition that the first segment total duration does not exceed a preset duration threshold, merging the initial audio segments included in the target segment group to obtain the target audio segment;
or, under the condition that the first segment total duration exceeds the preset duration threshold, splitting the target segment group to obtain a plurality of lower-layer audio groups; and merging the initial audio segments included in a lower-layer audio group to obtain the target audio segment.

In an example, for two adjacent initial audio segments, cosine similarity of their voiceprint features may be calculated as a first similarity; in the case that the first similarity is greater than or equal to a preset similarity threshold, it is determined that the voiceprint features of the two initial audio segments are similar (that is, the two initial audio segments may be considered to correspond to one speaker); and then the two initial audio segments are clustered into one audio segment group. Here, the preset similarity threshold may be set according to an application requirement. For example, the preset similarity threshold may be set to 0.85, which is not limited in the embodiment of the present disclosure.

After the plurality of audio segment groups are obtained, an audio segment group may be used as the target segment group, and the first segment total duration of the initial audio segments included in the target segment group may be obtained. For example, the initial audio segment included in the target segment group may undergo length superposition to obtain the first segment total duration. Then, under the condition that the first segment total duration does not exceed the preset duration threshold, the initial audio segments included in the target segment group are merged to obtain the target audio segment; or under the condition that the first segment total duration exceeds the preset duration threshold, the target segment group is split to obtain the plurality of lower-layer audio groups, and the initial audio segments included in a lower-layer audio group is merged to obtain the target audio segment. Herein, a second segment total duration of the initial audio segments included in the lower-layer audio group does not exceed the preset duration threshold. Here, the preset duration threshold may be set according to an application requirement. For example, the preset duration threshold may be set to 30 S, which is not limited in the embodiment of the present disclosure. The second segment total duration may be obtained by performing the length superposition on the initial audio segments included in the lower-layer audio group.

Referring to FIG. 2, as an example, audio data is segmented according to pause interval positions to obtain 6 initial audio segments, which are an initial audio segment A1, an initial audio segment A2, an initial audio segment A3, an initial audio segment A4, an initial audio segment A5, and an initial audio segment A6. Thereafter, based on a plurality of voiceprint features which correspond to a plurality of initial audio features in a one-to-one correspondence, adjacent initial audio segments with a similar voiceprint feature in the plurality of initial audio segments are clustered into an audio segment group, to obtain an audio segment group B1 and an audio segment group B2. Herein the audio segment group B1 includes the initial audio segment A1 and the initial audio segment A2; the audio segment group B2 includes the initial audio segment A3, the initial audio segment A4, the initial audio segment A5, and the initial audio segment A6.

Assuming that the first segment total duration of the audio segment group B1 does not exceed a preset duration threshold, the initial audio segments (i.e., the initial audio segment A1 and the initial audio segment A2) included in the audio segment group B1 may be merged to obtain a target audio segment C1. Assuming that the first segment total duration of the audio segment group B2 exceeds the preset duration threshold, the audio segment group B2 may be split to obtain a lower-layer audio group B21 (e.g., including the initial audio segment A3 and the initial audio segment A4) and a lower-layer audio group B22 (e.g., including the initial audio segment A5 and the initial audio segment A6); and the initial audio segments included in the lower-layer audio group B21 are merged to obtain a target audio segment C2, and the initial audio segments included in the lower-layer audio group B22 are merged to obtain a target audio segment C3.

In the above manner, according to the embodiment of the present disclosure, it is possible to segment the audio data according to the pause interval position to obtain the plurality of initial audio segments, obtain the voiceprint feature of the initial audio segment to obtain the plurality of voiceprint features, and merge at least a portion of the plurality of initial audio segments based on the plurality of voiceprint features to obtain the plurality of target audio segments. The intelligent segmentation mode according to the “speaker organized contents” realizes qualitative change from “physical segmentation” to “semantic segmentation”. In other words, voice contents of different speakers are not mechanically merged into the same target audio segment, but continuous sentences of the same speaker are intelligently clustered into the same target audio segment, so that rich and reliable context information is provided for subsequent speech recognition and the accuracy of language recognition is improved.

Moreover, when at least portion of the plurality of initial audio segments are merged based on the plurality of voiceprint features to obtain the plurality of target audio segments, the adjacent initial audio segments with similar voiceprint features in the plurality of initial audio segments are clustered into one audio segment group based on the plurality of voiceprint features to obtain the plurality of audio segment groups, and one of the plurality of audio segment group is taken as a target segment group to obtain the first segment total duration of the initial audio segments included in the target segment group, so that under the condition that the first segment total duration does not exceed the preset duration threshold, the initial audio segments included in the target segment group are merged to obtain the target audio segment; or under the condition that the first segment total duration exceeds the preset duration threshold, the target segment group is split to obtain the plurality of lower-layer audio groups and the initial audio segments included in a lower-layer audio group is merged to obtain the target audio segment. That is to say, in the embodiment of the present disclosure, an optimal balance between the accuracy and the promptness of the speech recognition can be intelligentialized. Specifically, the consistency of the contents of the same speaker can be preferentially ensured through voiceprint clustering, so that the accuracy of the speech recognition is improved. In the meanwhile, a duration threshold mechanism is introduced, so that overlong target audio segments caused by long-time speaking of a single person are prevented and the granularity of a single speech recognition task is moderate. The dynamic adjustment strategy can not only improve the accuracy of speech recognition from the source but also optimize the concurrency processing efficiency of the rear end, finally realizing the dual improvement of the accuracy rate and the promptness of the speech recognition.

After the target video is determined and the audio data of the target video is segmented to obtain the plurality of target audio segments, Step S103 of obtaining the plurality of text segments by performing speech recognition on the plurality of target audio segments according to the concurrent processing mechanism is performed.

In the embodiment of the present disclosure, Step S103, as a first optional implementation, may include:
obtaining a recognition difficulty level of the target video;
determining a first target model from a plurality of candidate recognition models based on the recognition difficulty level; and
obtaining the plurality of text segments by performing the speech recognition on the plurality of target audio segments according to the concurrent processing mechanism by using the first target model.

Herein, the recognition difficulty level may be a high difficulty level, a medium difficulty level or a low difficulty level, which may be specifically determined based on a video category of the target video.
(1) High difficulty level may correspond to:
Professional academics, e.g., scientific research paper reports, and high-level academic conferences;
Legislations and justices, e.g., court trial, and legal provisions interpretation;
Medical health, e.g., medical seminars, diagnostic discussions;
Complex acoustic environments, e.g., multi-person debates, noisy field interviews;
Important business meetings, e.g., cross-country negotiations, strategic decision meetings;
Dialect communication, e.g., local featured content, specific group interviews.
(2) Medium difficulty level may correspond to:
Academic lectures, e.g., college courses, technical sharing meetings;
Business finance, e.g., financial analysis, business interviews;
Information Technology (IT), e.g., technical publications, programming education;
Movies, e.g., science fiction movies, horror movies;
Documentary voiceover, e.g., nature and history documentaries (clearly pronounced but professional in content);
Standard meeting records, e.g., enterprise regular meetings, project discussions.
(3) Low difficulty level may correspond to:
   Daily conversation, e.g., video blogs, life sharing, daily interviews;
Clear broadcasts, e.g., weather forecasts, standard news bulletins;
Simple teaching, e.g., basic educational content, skill entry courses;
Entertainments, e.g., funny short-films, live games;
Telephone recordings, e.g., customer service recordings, clear call recordings.

In the embodiment of the disclosure, it is possible to select a large-parameter model from a plurality of candidate recognition models as a first target model under the condition that the recognition difficulty level of the target video is the high difficulty level; to select a medium parameter model from the plurality of candidate identification models as the first target model under the condition that the recognition difficulty level of the target video is the medium difficulty level; and to select a small parameter model from the plurality of candidate identification models as the first target model under the condition that the recognition difficulty level of the target video is the low difficulty level. Herein, the large parameter model may be a voice-to-text (Whisper) model with a total amount of parameters of 1550 Megabytes (MB); the medium parameter model may be a Whisper model with a total amount of parameters of 796 MB; the small parameter model may be a Whisper model with a total amount of parameters of 244 MB.

After the first target model is determined, the speech recognition may be performed on the plurality of target audio segments according to the concurrent processing mechanism by using the first target model to obtain the plurality of text segments. In an example, a first target number of first recognition threads may be initiated and the plurality of target audio segments may be relatively uniformly assigned to the first target number of recognition threads, such that one of the first recognition threads invokes a first target model and performs the speech recognition on the obtained target audio segment to obtain a corresponding text segment. Herein, the first target number may be set according to an application requirement. For example, the first target number may be set to 12, which is not limited in the embodiment of the present disclosure. The text segment may be in a SubRip Subtitle (SRT) format.

Exemplarily, if there are 240 target audio segments and 12 first recognition threads, the 240 target audio segments may be relatively uniformly assigned to the 12 first recognition threads. That is, each first recognition thread obtains 20 target audio segments. For a first recognition thread, the first recognition thread may perform speech recognition on the 20 target audio segments obtained by the first recognition thread to obtain 20 text segments corresponding to the 20 target audio segments in the one-to-one correspondence.

In the above manner, according to the embodiment of the present disclosure, it is possible to obtain the recognition difficulty level of the target video, determine the first target model from the plurality of candidate recognition models based on the recognition difficulty level, and perform the speech recognition on the plurality of target audio segments according to the concurrent processing mechanism by using the first target model to obtain the plurality of text segments. In other words, in the embodiment of the present disclosure, through fine classification of the recognition difficulty level, a stronger computing resource (e.g., the large parameter model) can be intelligently allocated to a video content with the high difficulty level, so as to ensure the transcription accuracy of key information; meanwhile, a moderate computing resource (e.g., the medium parameter model) can be allocated to a video content with the medium difficulty level; and a lightweight model (e.g., a small parameter model) is employed for a video content with the low difficulty level. This “on-demand computing resource” mechanism enables an optimal balance between resource scheduling and quality efficiency.

In the embodiment of the present disclosure, Step S103, as a second optional implementation, may include:
obtaining recognition difficulty scoring of a target audio segment;
determining, for a target audio segment, a second target model corresponding to the target audio segment from the plurality of candidate recognition models based on the recognition difficulty scoring of the target audio segment; and
obtaining the plurality of text segments by performing the speech recognition on the plurality of target audio segments according to the concurrent processing mechanism by using a plurality of second target models corresponding to the plurality of target audio segments in the one-to-one correspondence.

Herein, the recognition difficulty scoring can be used for representing the speech recognition difficulty of the target audio segment, and the recognition difficulty scoring and the speech recognition difficulty are in positive correlation. In an example, the recognition difficulty scoring of the target audio segment may be obtained by:
determining a plurality of evaluation dimensions; and
performing, for a target audio segment, recognition difficulty evaluation on the target audio segment from the plurality of evaluation dimensions to obtain a plurality of scores to be fused; and obtaining the recognition difficulty scoring of the target audio segment based on the plurality of scores to be fused.

Herein, the plurality of evaluation dimensions may include at least one of a first dimension, a second dimension or a third dimension.

In the embodiment of the present disclosure, the first dimension corresponds to a to-be-fused score of a signal-to-noise ratio; the second dimension corresponds to a to-be-fused score of a speech speed; and the third dimension corresponds to a to-be-fused score of a variance of fundamental frequency of speech.

Herein, the signal-to-noise ratio can be used for representing a signal strength ratio of speech data to background sound in the target audio segment, and the lower the signal-to-noise ratio is, the higher the difficulty in speech recognition is; the speech speed may be an average vocabulary number of the target audio piece per unit time (e.g., 30 S), and the faster the speech speed, the higher the difficulty in speech recognition; the variance of the fundamental frequency of the speech can be used for representing an intensity of pitch variation of the speaker in the target audio segment, and if the variance of the fundamental frequency of the speech is too small or too large, the speech recognition difficulty will be increased. Specifically, if the variance of fundamental frequency of the speech is too small, it may indicate that intonation is flat and monotonous and lacks rhythm change, which may result in that the recognition model is difficult to distinguish question sentences and statement sentences, and even difficult to distinguish word boundaries, thereby increasing the speech recognition difficulty; conversely, if the variance of the fundamental frequency of the speech is too large, it may indicate that the pitch varies dramatically, for example, excited speeches, singing, children speaking, and exaggerated animation dubbing. Extreme high and low pitch variations may change the formant structure of the sound, thereby increasing the speech recognition difficulty. Here, the variance of the fundamental frequency of the speech may estimate a fundamental frequency sequence from the target audio segment by using fundamental frequency extraction algorithm (e.g., Probabilistic YIN (PYIN) and Robust Algorithm for Pitch Tracking (RAPT)) and be obtained based on the fundamental frequency sequence. If the variance of fundamental frequency of the speech is smaller than or equal to a preset low-threshold variance, the variance of fundamental frequency of the speech may be too small. The preset low-threshold variance may be set according to an application requirement, which is not limited in the embodiment of the present disclosure. If the variance of fundamental frequency of the speech is greater than or equal to a preset high-threshold variance, the variance of fundamental frequency of the speech may be too large. The preset high-threshold variance may be set according to an application requirement, which is not limited in the embodiment of the present disclosure.

For a target audio segment, the recognition difficulty evaluation is performed on the target audio segment from the plurality of evaluation dimensions to obtain a plurality of scores to be fused, and then weighted summation is performed on the plurality of scores to be fused to obtain the recognition difficulty scoring of the target audio segment. Herein, when the weighted summation is performed on the plurality of scores to be fused to obtain the recognition difficulty scoring of the target audio segment, the weight distribution result used can be set according to an application requirement, which is not limited in the embodiment of the present disclosure.

In the embodiment of the disclosure, for a target audio segment, under the condition that the recognition difficulty scoring of the target audio segment is within a preset high-score range, a large parameter model may be selected from the plurality of candidate recognition models as the second target model corresponding to the target audio segment; under the condition that the recognition difficulty scoring of the target audio segment is within a preset medium-score range, a medium parameter model is selected from the plurality of candidate recognition models as a second target model corresponding to the target audio segment; and under the condition that the recognition difficulty scoring of the target audio segment is within in a preset low-score range, a small parameter model is selected from the plurality of candidate recognition models as a second target model corresponding to the target audio segment. Herein, the large parameter model may be a Whisper model with a total amount of parameters of 1550 MB; the medium parameter model may be a Whisper model with a total amount of parameters of 796 MB; and the small parameter model may be a Whisper model with a total amount of parameters of 244 MB.

After the plurality of second target models corresponding to the plurality of target audio segments in the one-to-one correspondence is determined, the speech recognition is performed on the plurality of target audio segments according to the concurrent processing mechanism by using the plurality of second target models corresponding to the plurality of target audio segments in the one-to-one correspondence to obtain the plurality of text segments. In an example, a second target number of second recognition threads may be initiated and the plurality of target audio segments may be relatively uniformly assigned to the second target number of second recognition threads, such that when a second recognition thread processes a target audio segment obtained by the second recognition thread, the second recognition thread invokes a second target model corresponding to the target audio segment and performs the speech recognition on the target audio segment to obtain a corresponding text segment. Herein, the second target number may be set according to an application requirement. For example, the second target number may be set to 12, which is not limited in the embodiment of the present disclosure. The text segment may be in SRT format.

Exemplarily, if there are 240 target audio segments and 12 second recognition threads, the 240 target audio segments may be relatively uniformly assigned to 12 second recognition threads. That is, each second recognition thread obtains 20 target audio segments. For a second recognition thread, the second recognition thread may perform speech recognition on the 20 target audio segments obtained by the second recognition thread to obtain 20 text segments corresponding to the 20 target audio segments in the one-to-one correspondence.

In the above manner, according to the embodiment of the present disclosure, it is possible to obtain the recognition difficulty scoring of a target audio segment, and for a target audio segment, determine a second target model corresponding to the target audio segment from the plurality of candidate recognition models based on the recognition difficulty scoring of the target audio segment, and then perform the speech recognition on the plurality of target audio segments according to the concurrent processing mechanism by using the plurality of second target models corresponding to the plurality of target audio segments in the one-to-one correspondence, so as to obtain the plurality of text segments. In other words, in the embodiment of the present disclosure, based on the principle of “good steel on the blade”, i.e., allocating the computing resources to where they are most needed, for a complex target audio segment, a stronger computing resource (e.g., a large parameter model) is initiated to ensure the accuracy of the speech recognition result; for a simple, clear target audio segment, a lightweight model (e.g., small parameter models) is enabled to improve speech recognition speed. Compared to a “one-size-fits-all” approach that assigns a single recognition model uniformly to the entire target video, this fine-grained and adaptive recognition model selection strategy achieves a higher global average recognition accuracy within the same or even shorter total processing time, while effectively reducing computational resource costs.

Moreover, when the recognition difficulty scoring of a target audio segment is obtained, the plurality of evaluation dimensions (for example, a first dimension corresponding to a signal-to-noise ratio, a second dimension corresponding to a speech speed, and a third dimension corresponding to a variance of fundamental frequency of speech) may be determined, and for a target audio segment, the recognition difficulty evaluation is performed on the target audio segment from the plurality of evaluation dimensions to obtain the plurality of scores to be fused, and then the recognition difficulty scoring of the target audio segment is obtained based on the plurality of scores to be fused. In this way, the limitations of relying on a single metric can be overcome, enabling a more comprehensive and accurate quantification of the true recognition difficulty of the target audio segments, thereby establishing a more reliable basis for subsequent adaptive selection of recognition models.

In some optional embodiments, Step S104 of “obtaining the target subtitle text by performing translation processing on the plurality of text segments” may include:
obtaining a video category of the target video;
constructing translation cue words based on the video category; and
obtaining the target subtitle text by performing the translation processing on the plurality of text segments based on the translation cue words by using a target large model.

Herein, the video category may be, but is not limited to, professional academic category, legislation and justice category, medical health category, complex acoustic environment, important business meeting, dialect communication category, academic lecture category, business finance category, IT category, movie category, documentary voiceover, standard meeting record, daily conversation category, clear broadcast category, simple teaching category, entertainment category, and telephone recording category.

After the video category of the target video is obtained, the translation cue words can be constructed based on the video category. That is, the translation cue words can be constructed based on recognition notice of the video category. For example, where the video category is a healthcare category, the recognition notice may include: ensuring absolute accuracy of professional medical terms and precise and objective sentence expression, and meeting standard terms of the medical industry; as another example, where the video category is a movie category, the recognition notice may include: reserving semantics and spoken expression style of a film scene; as another example, where the video category is a phone-call recording category, the recognition notice may include: processing common fuzzy, omitted and incomplete sentences in a recorded text, and converting fragmented spoken dialogue into a written language which is smooth and conforms to habit of a target language.

After the video category of the target video is obtained and the translation cue words are constructed based on the video category, the plurality of text segments can be translated based on the translation cue words by using the target large model to obtain the target subtitle text. The target large model may be a Large Language Model (LLM). Here, the LLM may be pre-trained or trained, and specifically may be a neural network model (for example, an autoregressive model of the Transformer architecture) having general linguistic knowledge, world knowledge and professional knowledge in various fields.

In the above manner, according to the embodiment of the present disclosure, it is possible to obtain the video category of the target video, construct the translation cue words based on the video category, and then translate the plurality of text segments based on the translation cue words by using the target large model to obtain the target subtitle text. That is, in the embodiment of the present disclosure, specialized translation cue words may be constructed by recognizing the video category of the target video, so that translation capability of the target large model is upgraded from “general” to “domain-specific”, thereby ensuring accurate conversion of specialized terms in a vertical domain (e.g., law, medical treatment, science and technology, etc.,) and automatically adapting to text styles (e.g., academic stringency and movie dialogue vividness) of different scenes, so as to effectively solve the semantic deviation problem of general translation in the vertical domain and improve the specialty, accuracy and scene fitness of the target subtitle text.

Further, in the embodiment of the present disclosure, when performing translation processing on the plurality of text segments based on the translation cue words to obtain the target subtitle text, the method may include:
splicing the plurality of text segments to obtain a text to be translated; and
obtaining the target subtitle text by performing the translation processing on the text to be translated based on the translation cue words by using the target large model.

Herein, when splicing the plurality of text segments to obtain a text to be translated, it is possible to splice the text segments according to a time axis identifier of a target audio segment. Therefore, the target subtitle text and the audio data can be accurately aligned after the translation processing is performed on the text to be translated by using the target large model based on the translation cue words to obtain the target subtitle text.

In other words, in the embodiment of the present disclosure, the plurality of text segments may be spliced first to obtain the text to be translated, and then the text to be translated is translated by using the target large model based on the translation cue words to obtain the target subtitle text. The method integrates all text segments into a complete text to be translated, provides richest and reliable context information for the target large model, and enables the target large model to perform text translation based on full-text understood words, reference relation and logic venation, ensuring that professional terms are unified and a language style is consistent in the context, and greatly improving the accuracy and readability of the target subtitle text.

In the embodiment of the present disclosure, when performing translation processing on the plurality of text segments based on the translation cue words to obtain the target subtitle text, the method may also include:
obtaining a plurality of segment translation results by performing the translation processing on a text segment based on the translation cue words by using the target large model; and
splicing the plurality of segment translation results to obtain the target subtitle text.

Herein, when splicing the plurality of segment translation results to obtain the target subtitle text, the plurality of segment translation results can be spliced according to the time axis identifier of the target audio segment. In this way, it is ensured that the obtained target subtitle text and audio data are accurately aligned.

That is, in the embodiment of the present disclosure, the translation processing is firstly performed on the text segment by using the target large model based on the translation cue words to obtain the plurality of segment translation results, and then the plurality of segment translation results may be spliced to obtain the target subtitle text. The method carries out independent translation on a single text segment, greatly reducing the dependence on the context length of the large target model, and making the demand of the large target model on computing resources more controllable; meanwhile, the translation failure of the single text segment does not affect the global translation result, improving the fault tolerance and stability of the subtitle generation method, and serving as an efficient and stable engineering implementation.

Further, the method for generating subtitle according to the embodiment of the present disclosure may further include:
determining a plurality of key subtitle contents from the target subtitle text;
determining, for a key subtitle content, a first target image corresponding to the key subtitle content from multi-frame video images of the target video; and establishing an association relationship between the key subtitle content and the first target image.

Herein, the plurality of key subtitle contents may be anchor subtitle contents corresponding to key nodes of the target video. Here, the key node may be, but is not limited to, a topic transition, a core question posed or solved, an important point or conclusion occurrence, a conclusive statement, or a key event occurrence, for example.

In the embodiment of the present disclosure, the plurality of key subtitle contents may be determined from the target subtitle text by using a content determination model. Herein, the content determination model may be LLM. Exemplarily, a content extraction prompt may be constructed and the plurality of key subtitle contents may be determined from the target subtitle text based on the content extraction prompt by using the content determination model. Herein, the content extraction prompt may be as follows:
You are a professional video content analysis expert who carefully analyzes the target subtitle text and determines the anchor subtitle contents (e.g., anchor sentences) representing the key nodes of the target video from the target subtitle text. Herein, the key node may be, but is not limited to, a topic transition, a core question posed or solved, an important point or conclusion occurrence, a conclusive statement, or a key event occurrence, for example.

In the embodiment of the present disclosure, after the plurality of key subtitle contents are determined from the target subtitle text, for a key subtitle content, the first target image corresponding to the key subtitle content is determined from the multi-frame video images of the target video, and the correspondence between the key subtitle content and the first target image is established.

Further, based on the above, the method for generating subtitle according to the embodiment of the present disclosure may further include:
determining, in response to a video seek request carrying the target subtitle content, a second target image having the association relationship with the target subtitle content from the multi-frame video images;
generating a video seek indication corresponding to the second target image; and
sending the video seek indication to a terminal device.

Herein, the video seek request may be sent by a target user based on the terminal device, and carries the target subtitle content; and the target subtitle content may correspond to one of the plurality of key subtitle contents. In an example, the target user may input at least one target vocabulary in a progress scheduling box of the target video to combine the at least one target vocabulary into the target subtitle content.

After the target subtitle content is obtained, a cosine similarity between the target subtitle content and the plurality of key subtitle contents can be calculated, respectively, to serve as a second similarity, the key subtitle content with the largest corresponding second similarity is used as user intention content from the plurality of key subtitle contents, and then the first target image which has an association relationship with the user intention content is determined from the multi-frame video images to serve as the second target image. Thereafter, the video seek indication corresponding to the second target image may be generated and transmitted to the terminal device. The terminal device may be used to adjust a play progress of the target video according to the video seek indication, that is, adjust the currently played image of the target video to the second target image.

In the above manner, according to the embodiment of the present disclosure, it is possible to determine the plurality of key subtitle contents from the target subtitle text, determine, for a key subtitle content, the first target image corresponding to the key subtitle content from multi-frame video images of the target video, and establish the association relationship between the key subtitle content and the first target image. Based on this, according to the embodiment of the present disclosure, it is possible to determine, in response to a video seek request carrying the target subtitle content, a second target image having the association relationship with the target subtitle content from the multi-frame video images, generate the video seek indication corresponding to the second target image; and send the video seek indication to the terminal device. That is, in the embodiment of the present disclosure, the “semantic navigation” of the video content can be implemented in a manner of intelligently extracting the key subtitle content and accurately associating the corresponding video image. As such, a user can input any target subtitle content and instantly seek to the corresponding video segment with a single click. This eliminates the guesswork inherent in traditional approaches where the user manually drags the progress bar to navigate, thereby significantly improving the efficiency of information retrieval and consumption, and greatly enhancing the overall user experience.

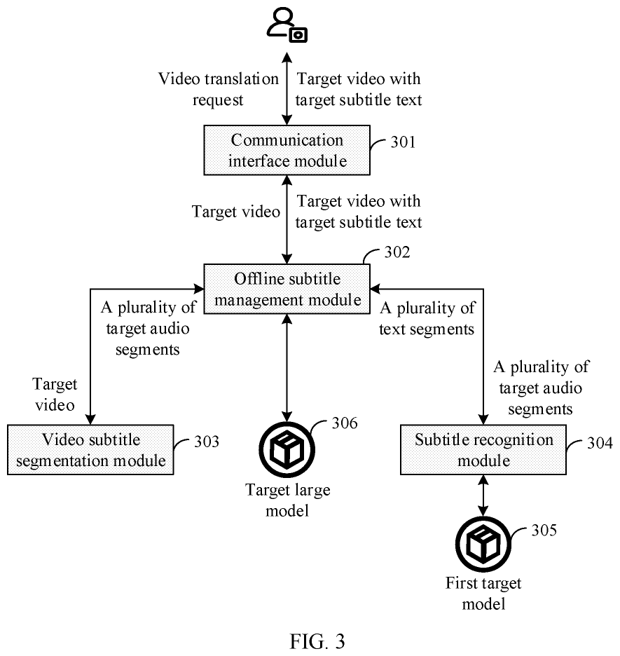

Hereinafter, a complete flow of the method for generating subtitle according to an embodiment of the present disclosure will be described with reference to FIG. 3.

A communication interface module 301 receives a video translation request issued by a target user based on a terminal device and determines a target video based on the video translation request.

The communication interface module 301 sends the target video to an offline subtitle management module 302, and the offline subtitle management module 302 performs unified translation scheduling. Specifically, the offline subtitle management module 302 sends the target video to a video subtitle segmentation module 303, so that the video subtitle segmentation module 303 segments audio data of the target video to obtain a plurality of target audio segments, and returns the plurality of target audio segments to the offline subtitle management module 302; the offline subtitle management module 302 sends the plurality of target audio segments to a subtitle recognition module 304, so that the subtitle recognition module 304 performs speech recognition on the plurality of target audio segments according to a concurrent processing mechanism by using a first target model 305 (e.g., Whisper model) to obtain the plurality of text segments, and returns the plurality of text segments to the offline subtitle management module 302; the offline subtitle management module 302 splices the plurality of text segments to obtain a text to be translated, and translates the text to be translated by using a target large model 306 (e.g., LLM) based on the translation cue words to obtain a target subtitle text.

Thereafter, the offline subtitle management module 302 may fuse the target subtitle text into the target video to obtain the target video with the target subtitle text, and the communication interface module 301 sends the target video with the target subtitle text to the terminal device for the target user to watch.

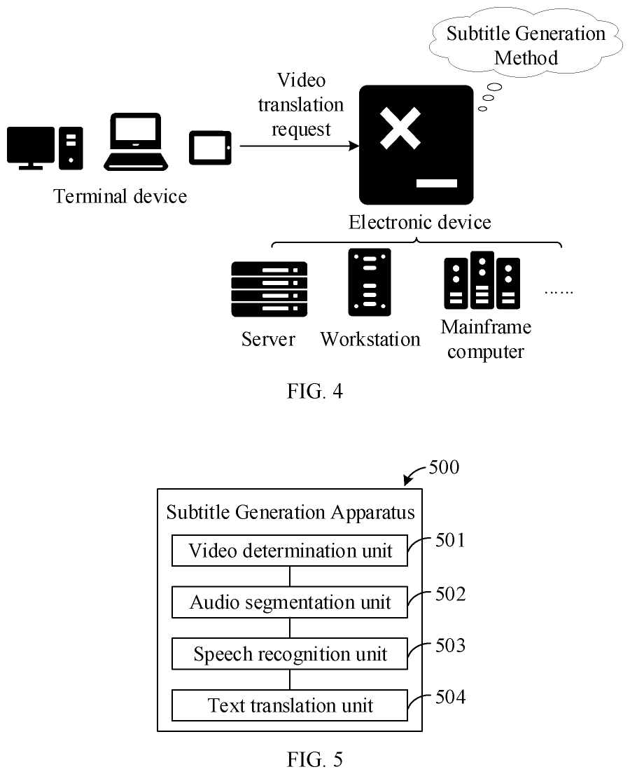

FIG. 4 is a schematic diagram of an application scenario of the method for generating subtitle according to the embodiment of the present disclosure.

The method for generating subtitle according to the embodiment of the disclosure is applied to an electronic device which may be a server, a workstation, a mainframe computer, or other similar computing devices.

Here, the electronic device is configured to:
determine a target video;
segment audio data of the target video to obtain a plurality of target audio segments;
obtain a plurality of text segments by performing speech recognition on the plurality of target audio segments according to a concurrent processing mechanism, wherein the plurality of text segments correspond to the plurality of target audio segments in a one-to-one correspondence; and
obtain a target subtitle text by performing translation processing on the plurality of text segments

In the embodiment of the present disclosure, the determination of the target video may include determining the target video in response to a video translation request. The video translation request can be sent by a target user through a world wide Web (Web) or a Native App (NA) based on a terminal device, and carry a video identifier. Here, the terminal device may be a conventional computer, a smart phone, a personal digital processor, or other similar computing devices.

It should be noted that, in the embodiment of the present disclosure, the schematic diagram of the application scenario shown in FIG. 4 is only illustrative and not limiting. A person skilled in the related art may make various obvious changes and/or substitutions based on the example of FIG. 4, and the obtained technical solution still falls within the disclosure scope of the embodiments of the present disclosure.

In order to better implement the method for generating subtitle as set forth above, an embodiment of the present disclosure also provides an apparatus for generating subtitle, which may be integrated in an electronic device. Herein, the electronic device may be a server, a workstation, a mainframe computer, or other similar computing devices. Hereinafter, an apparatus 500 for generating subtitle according to the embodiment of the present disclosure will be described with reference to a schematic block diagram shown in FIG. 5.

The apparatus 500 for generating subtitle includes:
a video determination unit 501 configured to determine a target video;
an audio segmentation unit 502 configured to segment audio data of the target video to obtain a plurality of target audio segments;
a speech recognition unit 503 configured to obtain a plurality of text segments by performing speech recognition on the plurality of target audio segments according to a concurrent processing mechanism, wherein the plurality of text segments correspond to the plurality of target audio segments in a one-to-one correspondence; and
a text translation unit 504 configured to obtain a target subtitle text by performing translation processing on the plurality of text segments.

In some optional embodiments, the audio segmentation unit 502 is configured to:
segment the audio data according to a pause interval position to obtain a plurality of initial audio segments;
obtain a voiceprint feature of an initial audio segment to obtain a plurality of voiceprint features; and
merge at least a portion of the plurality of initial audio segments based on the plurality of voiceprint features to obtain the plurality of target audio segments.

In some optional embodiments, the audio segmentation unit 502 is configured to:
cluster adjacent initial audio segments with similar voiceprint features in the plurality of initial audio segments into an audio segment group based on the plurality of voiceprint features to obtain a plurality of audio segment groups;
take an audio segment groups as a target segment group, and obtain a first segment total duration of the initial audio segments included in the target segment group;
under the condition that the first segment total duration does not exceed a preset duration threshold, merge the initial audio segments included in the target segment group to obtain the target audio segment;
or, under the condition that the first segment total duration exceeds the preset duration threshold, split the target segment group to obtain a plurality of lower-layer audio groups; and merge the initial audio segments included in a lower-layer audio group to obtain the target audio segment, wherein a second segment total duration of the initial audio segments included in the lower-layer audio group does not exceed the preset duration threshold.

In some optional embodiments, the speech recognition unit 503 is configured to:
obtain a recognition difficulty level of the target video;
determine a first target model from a plurality of candidate recognition models based on the recognition difficulty level; and
obtain the plurality of text segments by performing the speech recognition on the plurality of target audio segments according to the concurrent processing mechanism by using the first target model.

In some optional embodiments, the speech recognition unit 503 is configured to:
obtain recognition difficulty scoring of a target audio segment;
determine, for a target audio segment, a second target model corresponding to the target audio segment from the plurality of candidate recognition models based on the recognition difficulty scoring of the target audio segment; and
obtain the plurality of text segments by performing the speech recognition on the plurality of target audio segments according to the concurrent processing mechanism by using a plurality of second target models corresponding to the plurality of target audio segments in the one-to-one correspondence.

In some optional embodiments, the speech recognition unit 503 is configured to:
determine a plurality of evaluation dimensions;
perform, for a target audio segment, recognition difficulty evaluation on the target audio segment from the plurality of evaluation dimensions to obtain a plurality of scores to be fused; and obtain the recognition difficulty scoring of the target audio segment based on the plurality of scores to be fused.

In some optional embodiments, the plurality of evaluation dimensions includes at least one of a first dimension corresponding to a signal-to-noise ratio, a second dimension corresponding to a speech speed, or a third dimension corresponding to a variance of fundamental frequency of speech.

In some optional embodiments, the video determination unit 501 is configured to one of:
determine the target video in response to a video translation request; or
determine a first candidate video; obtain an original language category of the first candidate video; and take the first candidate video as the target video in the case that the original language category is different from a reference language category.

In some optional embodiments, the text translation unit 504 is configured to:
obtain a video category of the target video;
construct translation cue words based on the video category; and
obtain the target subtitle text by performing the translation processing on the plurality of text segments based on the translation cue words by using a target large model.

In some optional embodiments, the text translation unit 504 is configured to:
splice the plurality of text segments to obtain a text to be translated; and
obtain the target subtitle text by performing the translation processing on the text to be translated based on the translation cue words by using the target large model.

In some optional embodiments, the text translation unit 504 is configured to:
obtain a plurality of segment translation results by performing the translation processing on a text segment based on the translation cue words by using the target large model; and
splice the plurality of segment translation results to obtain the target subtitle text.

In some optional embodiments, the apparatus 500 for generating subtitle further includes an index association unit configured to:
determine a plurality of key subtitle contents from the target subtitle text;
determine, for a key subtitle content, a first target image corresponding to the key subtitle content from multi-frame video images of the target video; and establish an association relationship between the key subtitle content and the first target image.

In some optional embodiments, the apparatus 500 for generating subtitle further includes an index response unit configured to:
determine, in response to a video seek request carrying the target subtitle content, a second target image having the association relationship with the target subtitle content from the multi-frame video images, wherein the target subtitle content corresponds to one of the plurality of key subtitle contents;
generate a video seek indication corresponding to the second target image; and
send the video seek indication to a terminal device, wherein the terminal device is used to adjust a play progress of the target video according to the video seek indication.

In the embodiment of the present disclosure, specific functions and examples of each unit in the apparatus 500 for generating subtitle may refer to the related description of the corresponding steps in the method for generating subtitle according to the above embodiments, and will not be repeated herein.

In the technical scheme of the disclosure, the collection, storage, and use of users'personal information are conducted in compliance with all applicable laws and regulations and are consistent with public order and good morals.

According to embodiments of the present disclosure, the present disclosure also provides an electronic device, a readable storage medium and a computer program product.

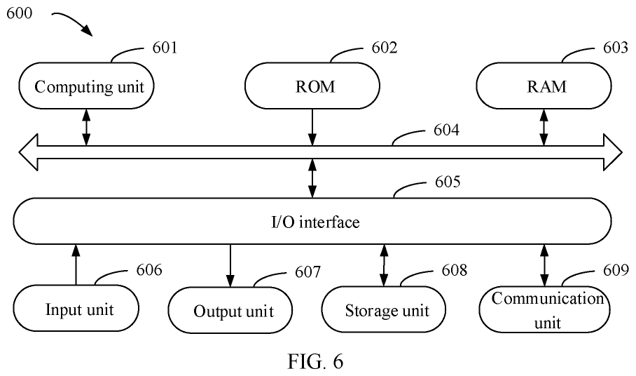

FIG. 6 shows a schematic block diagram of an exemplary electronic device 600 that may be used to implement the embodiments of the present disclosure. The electronic device 600 is intended to represent various forms of digital computers, such as an automotive computing device, a laptop, a desktop, a workstation, a personal digital assistant, a server, a blade server, a mainframe computer, and other suitable computers. The electronic device 600 may also represent various forms of mobile devices, such as a personal digital processing, a cellular phone, a smart phone, a wearable device and other similar electronic devices. The components shown herein, their connections and relationships, and their functions are merely examples, and are not intended to limit the implementation of the present disclosure described and/or required herein.

As shown in FIG. 6, the electronic device 600 includes a computing unit 601 that may perform various appropriate actions and processes according to a computer program stored in a Read-Only Memory (ROM) 602 or a computer program loaded from a storage unit 608 into a Random Access Memory (RAM) 603. Various programs and data required for an operation of device 600 may also be stored in the RAM 603. The computing unit 601, the ROM 602 and the RAM 603 are connected to each other through a bus 604. The input/output (I/O) interface 605 is also connected to the bus 604.

A plurality of components in the electronic device 600 are connected to the I/O interface 605, and include an input unit 606 such as a keyboard, a mouse, or the like; an output unit 607 such as various types of displays, speakers, or the like; the storage unit 608 such as a magnetic disk, an optical disk, or the like; and a communication unit 609 such as a network card, a modem, a wireless communication transceiver, or the like. The communication unit 609 allows the electronic device 600 to exchange information/data with other devices through a computer network such as the Internet and/or various telecommunication networks.

The computing unit 601 may be various general-purpose and/or special-purpose processing components with processing and computing capabilities. Some examples of the computing unit 601 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 601 performs various methods and processing described above, such as the above the method for generating subtitle. For example, in some implementations, the above method for generating subtitle may be implemented as a computer software program tangibly contained in a computer-readable medium, such as the storage unit 608. In some implementations, a part or all of the computer program may be loaded and/or installed on the device 600 via the ROM 602 and/or the communication unit 609. When the computer program is loaded into RAM 603 and executed by the computing unit 601, one or more steps of the method for generating subtitle described above may be performed. Alternatively, in other implementations, the computing unit 601 may be configured to perform the above method for generating subtitle by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM) or a flash memory, an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

An embodiment of the present disclosure also provides a non-transitory computer-readable storage medium storing a computer instruction thereon, wherein the computer instruction is used to cause a computer to execute the method for generating subtitle.

An embodiment of the present disclosure also provides a computer program product, including a computer program which, when executed by a processor, implements the method for generating subtitle.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein. Moreover, in the present disclosure, the relational terms such as “first”, “second” and the like may be used solely to distinguish one entity or action from another entity or action without necessarily requiring or implying any actual relationship or order between such entities or actions. In addition, “a plurality” in the present disclosure may be understood as at least two.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for generating subtitle, comprising:
determining a target video;
segmenting audio data of the target video to obtain a plurality of target audio segments;
obtaining a plurality of text segments by performing speech recognition on the plurality of target audio segments according to a concurrent processing mechanism, wherein the plurality of text segments correspond to the plurality of target audio segments in a one-to-one correspondence;
obtaining a target subtitle text by performing translation processing on the plurality of text segments.

2. The method of claim 1, wherein the segmenting of the audio data of the target video to obtain the plurality of target audio segments, comprises:
segmenting the audio data according to a pause interval position to obtain a plurality of initial audio segments;
obtaining a voiceprint feature of an initial audio segment to obtain a plurality of voiceprint features; and
merging at least a portion of the plurality of initial audio segments based on the plurality of voiceprint features to obtain the plurality of target audio segments.

3. The method of claim 2, wherein the merging of at least the portion of the plurality of initial audio segments based on the plurality of voiceprint features to obtain the plurality of target audio segments, comprises:
clustering adjacent initial audio segments with similar voiceprint features in the plurality of initial audio segments into an audio segment group based on the plurality of voiceprint features to obtain a plurality of audio segment groups;
taking an audio segment group as a target segment group, and obtaining a first segment total duration of the initial audio segments included in the target segment group;
under the condition that the first segment total duration does not exceed a preset duration threshold, merging the initial audio segments included in the target segment group to obtain the target audio segment;
or, under the condition that the first segment total duration exceeds the preset duration threshold, splitting the target segment group to obtain a plurality of lower-layer audio groups; and merging the initial audio segments included in a lower-layer audio group to obtain the target audio segment, wherein a second segment total duration of the initial audio segments included in the lower-layer audio group does not exceed the preset duration threshold.

4. The method of claim 2, wherein the obtaining of the plurality of text segments by performing the speech recognition on the plurality of target audio segments according to the concurrent processing mechanism, comprises:
obtaining a recognition difficulty level of the target video;
determining a first target model from a plurality of candidate recognition models based on the recognition difficulty level; and
obtaining the plurality of text segments by performing the speech recognition on the plurality of target audio segments according to the concurrent processing mechanism by using the first target model.

5. The method of claim 2, wherein the obtaining of the plurality of text segments by performing the speech recognition on the plurality of target audio segments according to the concurrent processing mechanism, comprises:
obtaining recognition difficulty scoring of a target audio segment;
determining, for a target audio segment, a second target model corresponding to the target audio segment from the plurality of candidate recognition models based on the recognition difficulty scoring of the target audio segment; and
obtaining the plurality of text segments by performing the speech recognition on the plurality of target audio segments according to the concurrent processing mechanism by using a plurality of second target models corresponding to the plurality of target audio segments in the one-to-one correspondence.

6. The method of claim 5, wherein the obtaining of the recognition difficulty scoring of the target audio segment, comprises:
determining a plurality of evaluation dimensions; and
performing, for a target audio segment, recognition difficulty evaluation on the target audio segment from the plurality of evaluation dimensions to obtain a plurality of scores to be fused; and obtaining the recognition difficulty scoring of the target audio segment based on the plurality of scores to be fused.

7. The method of claim 6, wherein the plurality of evaluation dimensions comprise at least one of a first dimension corresponding to a signal-to-noise ratio, a second dimension corresponding to a speech speed, or a third dimension corresponding to a variance of fundamental frequency of speech.

8. The method of claim 1, wherein the determining of the target video comprises one of:
determining the target video in response to a video translation request; or
determining a first candidate video; obtaining an original language category of the first candidate video; and taking the first candidate video as the target video in the case that the original language category is different from a reference language category.

9. The method of claim 1, wherein the obtaining of the target subtitle text by performing the translation processing on the plurality of text segments, comprises:
obtaining a video category of the target video;
constructing translation cue words based on the video category; and
obtaining the target subtitle text by performing the translation processing on the plurality of text segments based on the translation cue words by using a target large model.

10. The method of claim 9, wherein the obtaining of the target subtitle text by performing the translation processing on the plurality of text segments based on the translation cue words by using the target large model, comprises:
splicing the plurality of text segments to obtain a text to be translated; and
obtaining the target subtitle text by performing the translation processing on the text to be translated based on the translation cue words by using the target large model.

11. The method of claim 9, wherein the obtaining of the target subtitle text by performing the translation processing on the plurality of text segments based on the translation cue words by using the target large model, comprises:
obtaining a plurality of segment translation results by performing the translation processing on a text segment based on the translation cue words by using the target large model; and
splicing the plurality of segment translation results to obtain the target subtitle text.

12. The method of claim 1, further comprising:
determining a plurality of key subtitle contents from the target subtitle text;
determining, for a key subtitle content, a first target image corresponding to the key subtitle content from multi-frame video images of the target video; and establishing an association relationship between the key subtitle content and the first target image.

13. The method of claim 12, further comprising:
determining, in response to a video seek request carrying the target subtitle content, a second target image having the association relationship with the target subtitle content from the multi-frame video images;
generating a video seek indication corresponding to the second target image; and
sending the video seek indication to a terminal device, wherein the terminal device is used to adjust a play progress of the target video according to the video seek indication.

14. An electronic device, comprising:
at least one processor; and
a memory connected in communication with the at least one processor;
wherein the memory stores an instruction executable by the at least one processor, and the instruction, when executed by the at least one processor, enables the at least one processor to execute:
determining a target video;
segmenting audio data of the target video to obtain a plurality of target audio segments;
obtaining a plurality of text segments by performing speech recognition on the plurality of target audio segments according to a concurrent processing mechanism, wherein the plurality of text segments correspond to the plurality of target audio segments in a one-to-one correspondence;
obtaining a target subtitle text by performing translation processing on the plurality of text segments.

15. The electronic device of claim 14, wherein the instruction, when executed by the at least one processor, enables the at least one processor to execute the segmenting of the audio data of the target video to obtain the plurality of target audio segments, by:
segmenting the audio data according to a pause interval position to obtain a plurality of initial audio segments;
obtaining a voiceprint feature of an initial audio segment to obtain a plurality of voiceprint features; and
merging at least a portion of the plurality of initial audio segments based on the plurality of voiceprint features to obtain the plurality of target audio segments.

16. The electronic device of claim 15, wherein the instruction, when executed by the at least one processor, enables the at least one processor to execute the merging of at least the portion of the plurality of initial audio segments based on the plurality of voiceprint features to obtain the plurality of target audio segments, by:
clustering adjacent initial audio segments with similar voiceprint features in the plurality of initial audio segments into an audio segment group based on the plurality of voiceprint features to obtain a plurality of audio segment groups;
taking an audio segment group as a target segment group, and obtaining a first segment total duration of the initial audio segments included in the target segment group;
under the condition that the first segment total duration does not exceed a preset duration threshold, merging the initial audio segments included in the target segment group to obtain the target audio segment;
or, under the condition that the first segment total duration exceeds the preset duration threshold, splitting the target segment group to obtain a plurality of lower-layer audio groups; and merging the initial audio segments included in a lower-layer audio group to obtain the target audio segment, wherein a second segment total duration of the initial audio segments included in the lower-layer audio group does not exceed the preset duration threshold.

17. The electronic device of claim 15, wherein the instruction, when executed by the at least one processor, enables the at least one processor to execute the obtaining of the plurality of text segments by performing the speech recognition on the plurality of target audio segments according to the concurrent processing mechanism, by:
obtaining a recognition difficulty level of the target video;
determining a first target model from a plurality of candidate recognition models based on the recognition difficulty level; and
obtaining the plurality of text segments by performing the speech recognition on the plurality of target audio segments according to the concurrent processing mechanism by using the first target model.

18. A non-transitory computer-readable storage medium storing a computer instruction thereon, wherein the computer instruction is used to cause a computer to execute:
determining a target video;
segmenting audio data of the target video to obtain a plurality of target audio segments;
obtaining a plurality of text segments by performing speech recognition on the plurality of target audio segments according to a concurrent processing mechanism, wherein the plurality of text segments correspond to the plurality of target audio segments in a one-to-one correspondence;
obtaining a target subtitle text by performing translation processing on the plurality of text segments.

19. The non-transitory computer-readable storage medium of claim 18, wherein the computer instruction is used to cause the computer to execute the segmenting of the audio data of the target video to obtain the plurality of target audio segments, by:
segmenting the audio data according to a pause interval position to obtain a plurality of initial audio segments;
obtaining a voiceprint feature of an initial audio segment to obtain a plurality of voiceprint features; and
merging at least a portion of the plurality of initial audio segments based on the plurality of voiceprint features to obtain the plurality of target audio segments.

20. The non-transitory computer-readable storage medium of claim 19, wherein the computer instruction is used to cause the computer to execute the merging of at least the portion of the plurality of initial audio segments based on the plurality of voiceprint features to obtain the plurality of target audio segments, by:
clustering adjacent initial audio segments with similar voiceprint features in the plurality of initial audio segments into an audio segment group based on the plurality of voiceprint features to obtain a plurality of audio segment groups;
taking an audio segment group as a target segment group, and obtaining a first segment total duration of the initial audio segments included in the target segment group;
under the condition that the first segment total duration does not exceed a preset duration threshold, merging the initial audio segments included in the target segment group to obtain the target audio segment;
or, under the condition that the first segment total duration exceeds the preset duration threshold, splitting the target segment group to obtain a plurality of lower-layer audio groups; and merging the initial audio segments included in a lower-layer audio group to obtain the target audio segment, wherein a second segment total duration of the initial audio segments included in the lower-layer audio group does not exceed the preset duration threshold.
